(19) United States
(12) Patent Application Publication
(10) Pub. No.: US 2025/0282036 A1
(43) Pub. Date: Sep. 11, 2025

(54) Rotary Hammer Bit Removal Apparatus and Method of Removing a Rotary Hammer Bit

(71) Applicant: Elias De Los Santos, SR., San Jose, CA (US)

(72) Inventor: Elias De Los Santos, SR., San Jose, CA (US)

(21) Appl. No.: 19/072,852

(22) Filed: Mar. 6, 2025

Related U.S. Application Data
(60) Provisional application No. 63/562,207, filed on Mar. 6, 2024.

(51) Int. Cl. B25B 21/02

(52) U.S. Cl. CPC B25B 21/02

(57) ABSTRACT

An adapter which allows an impact wrench to be coupled to a tool bit for a rotary hammer and thereby rotate the tool bit in either direction. The adapter has a shaft member having a proximate end and a distal end. The proximate end has a rear facing axial opening configured to receive an anvil from the impact wrench. The distal end of the shaft member is coupled with a chuck assembly which is configured to releasably engage a shank of the tool bit and thereby rotate the tool bit. The adapter has a sleeve member which encloses the shaft member and allows the shaft member to rotate within the sleeve member. A handle member may be attached to the sleeve member, wherein the handle member may be utilized to apply a pulling force to the adapter to assist in withdrawal of the tool bit from a foundation.

### BACKGROUND OF THE INVENTION

The present invention relates generally to a tool bit removal system, and more specifically to a removal system which recovers tool bits which were stuck while being used with a rotary hammer, also known as a percussion drill. It is to be appreciated that a rotary hammer is to be distinguished from a hammer drill which is less powerful, and which utilizes a different chuck mechanism for retaining a tool bit than the rotary hammer.

Rotary hammers are heavy-duty tools designed for drilling through concrete, masonry, and the like in construction projects by combining the rotary action of a drill bit with a hammer action. Utilizing a piston driving system, a rotary hammer creates a powerful hammering action which allows the tool bit to break through tough materials. Rotary hammers can be used for chiseling and demolition work, making the devices very useful in construction projects. Rotary hammers are often utilized in specialty applications such as drilling a clearance hole within wood and concrete.

As compared to a conventional drill and hammer drills, which grip the shank of a drill bit with a three-jaw adjustable chuck to prevent rotation of the bit within the chuck during drilling operations, the “chuck” of a rotary hammer allows the tool bit to float axially within the chuck to simultaneously to allow both the hammering and rotating action, either separately or simultaneously. This chuck is known as the “slotted drive system” or SDS. The SDS chuck is a spring-loaded mechanism of which there are two types SDS-Plus and SDS-Max, with the former suitable for hole size diameters generally ranging from ⅝-inch to ¾-inch and the latter suitable for hole size diameters generally ranging from ⅜-inch to 2-inch. Unlike the drill bits which are used with a conventional drill, which have a smooth shank, the tool bits for rotary hammers have a splined shank which is compatible with the SDS chuck of the rotary hammer, with the tool bit having the nomenclature SDS, SDS-Plus and SDS-Max. These spline shanks lock into the SDS chuck by a spring-biased key or ball bearing which engages a groove of the splined shank, allowing the bit to reciprocate independently of the chuck.

While very effective in drilling and hammering into a matrix material, a rotary hammer applies the hammering action only while penetrating the matrix material. Some rotary hammers only allow rotation in the forward direction without a reverse direction option. As a result, the rotary hammer may urge the tool bit into a matrix material but not have the functionality to withdraw the tool bit from the material, resulting in the tool bit becoming stuck in the matrix material.

In one common application, a rotary hammer is used to drill a hole for setting an anchor for attaching a fixture to a cured concrete foundation adjacent to a rebar-reinforced retaining wall. To comply with the applicable building codes, the anchor hole typically must be drilled to a depth ranging from 2″ to 60″. In this situation, there can be several layers of rebar within the retaining wall and extending into the foundation, which creates a high likelihood that the drill bit intersects the rebar during the downward drilling process. When this occurs, metal shavings from the rebar can cause the drill bit to bind up and get stuck. Because the rotary hammer provides no hammer action to facilitate coming out of a hole, and because many hammer drills do not have a reverse direction option, removal of the drill bit from the foundation can be a substantial problem. The problem can be exacerbated because there may be limited working space around the stuck tool bit because of the pre-installed structural members surrounding the location. A stuck tool bit can cause costly project delays and even result in design modifications which require the resubmission of plans for further review and approval.

### SUMMARY OF THE INVENTION

Embodiments of the present invention provide an apparatus which provides a solution to the above-identified problem. Embodiments of the disclosed apparatus provide an adapter which allows a user to connect a pneumatically, hydraulically or electrically powered impact wrench to the splined shaft of the rotary hammer tool bit thereby providing the user to apply both forward (clockwise) and reverse (counterclockwise) directions to the rotary tool bit. The impact wrench provides the user the ability to apply repeated forward and reverse rotational impact with substantial torque to the rotary hammer tool bit to break it free.

Relative to a vertical orientation, the adapter comprises an upper end and a lower end. The upper end comprises a sleeve member and an internal shaft member disposed within the sleeve member. The internal shaft member has a receptacle configured to receive the anvil of the impact wrench. The lower end of the adapter comprises has a chuck mechanism coupled to the internal shaft member, where the chuck mechanism is configured to receive and releasably attach to the spline end of the tool bit.

The chuck mechanism may be configured to be actuated by applying a reciprocating motion to a grip assembly of the lower end, where the motion causes an internal key mechanism to either grasp or release the spline end of the tool bit by the interaction of key members of the key mechanism with a wedge or step structure axially disposed within the interior of the grip assembly. As the grip assembly is reciprocated, each key member has an outward facing surface which interacts with an inward facing surface of a wedge member of the wedge structure, where the interaction either causes the key member to be urged inwardly toward the tool bit or allows the key member to move outwardly away from the tool bit. When the position of the key members with respect to the inward facing wedge members allows outward movement of the key members away from the tool bit, biasing mechanisms, such as internal springs, may assist in the disengagement of the key members from the tool bit.

The grip assembly may be configured so that the chuck mechanism locks onto the shank of the tool bit by reciprocation in a downward motion or in an upward motion. The grip assembly is axially biased by a heavy-duty spring to retain the chuck mechanism in a locked configuration.

Alternatively, the chuck mechanism may be actuated by manual compression of the grip assembly which causes the engagement of the key members with the spline structure of the tool bit. Once the key members have engaged the spline structure, fasteners or other mechanisms are tightened to maintain the grip assembly in the compressed configuration with the key members affirmatively locked into the spline structure of the tool bit.

In all embodiments of the invention, the shaft member may freely rotate within the sleeve member and the grip assembly while the chuck assembly may freely rotate with the grip assembly. All embodiments of the apparatus may further comprise an extending handle assembly which attaches to the sleeve member. The extending handle assembly allows a user to apply upward force on the tool bit as the torque is being applied to the tool bit.

### BRIEF DESCRIPTION OF THE DRAWINGS

FIG. 1 depicts a situation in which embodiments of the present invention may provide a solution for recovery of a stuck rotary hammer bit.

FIG. 2 shows different views about the exterior circumference of a shank of a known tool bit utilized with rotary hammers, showing an SDS-Max spline pattern utilized on the shank of the tool bit, with FIG. 2a showing an oblique view of the protruding axial key member and an oblique view of one of the elliptically-shaped notches, FIG. 2b showing a front view of the protruding axial key member, FIG. 2c showing a front view of the axial keyway opposite the protruding axial and the relative positions of the elliptically-shaped notches on opposite sides of the shank, and FIG. 2d showing a front view of the one of the elliptically-shaped notches of the shank.

FIG. 3 shows a top view of the shank for the tool bit shown in FIG. 2.

FIG. 4 shows an embodiment of the present adapter positioned between a pneumatic wrench on one end and a rotary hammer bit.

FIG. 5 shows a top view of the adapter of FIG. 4 showing the square drive receptacle which is configured to receive the square anvil of a pneumatic wrench.

FIG. 6 shows a bottom view of the adapter of FIG. 4 showing the chuck mechanism which is configured to receive and secure to the spline of a tool bit.

FIG. 7 shows a perspective view of the adapter of FIG. 4.

FIG. 8 shows a side view of the adapter of FIG. 4.

FIG. 9 shows a sectioned view of the adapter taken along line 9-9 of FIG. 8, showing the chuck mechanism in a closed position.

FIG. 10 shows an embodiment of a coupling mechanism which may be utilized for connecting a shaft member of the adapter to a chuck shaft member.

FIG. 11 shows a sectioned view of the embodiment of the adapter depicted in FIG. 9 showing the chuck mechanism in an open position, ready to receive a tool bit.

FIG. 12 shows a sectioned view of the embodiment of the adapter depicted in FIG. 9 showing the chuck mechanism in the open position with the shank of a rotary hammer bit positioned in the chuck mechanism.

FIG. 13 shows a sectioned view of the embodiment of the adapter depicted in FIG. 9 showing the chuck mechanism in a closed position with the shank of a rotary hammer bit locked within the chuck mechanism.

FIG. 14 shows a second embodiment of the present adapter positioned between a pneumatic wrench on one end and a rotary hammer bit.

FIG. 15 shows a top view of the adapter shown in FIG. 14 showing the square drive receptacle which is configured to receive the square anvil of a pneumatic wrench.

FIG. 16 shows a bottom view of the adapter shown in FIG. 14 which partially shows the chuck mechanism which is configured to receive and secure to the shank of a rotary hammer bit.

FIG. 17 shows a perspective view of the adapter of FIG. 14.

FIG. 18 shows a side view of the adapter of FIG. 14.

FIG. 19 shows a sectioned view taken along line 19-19 of FIG. 18.

FIG. 20 shows the sectioned view of FIG. 19 showing a shank of a rotary hammer bit positioned within the chuck mechanism.

FIG. 21 shows a second perspective view of the adapter shown in FIG. 14 with the chuck mechanism in an open position.

FIG. 22 shows a sectioned view taken along line 22-22 of FIG. 21.

FIG. 23 shows the sectioned view of FIG. 22 further showing a shank of a rotary hammer bit positioned within the chuck mechanism.

FIG. 24 shows a sectioned view taken along line 24-24 of FIG. 21.

FIG. 25 shows the sectioned view of FIG. 24 further showing a shank of a rotary hammer bit positioned within the chuck mechanism.

### DETAILED DESCRIPTION OF THE INVENTION

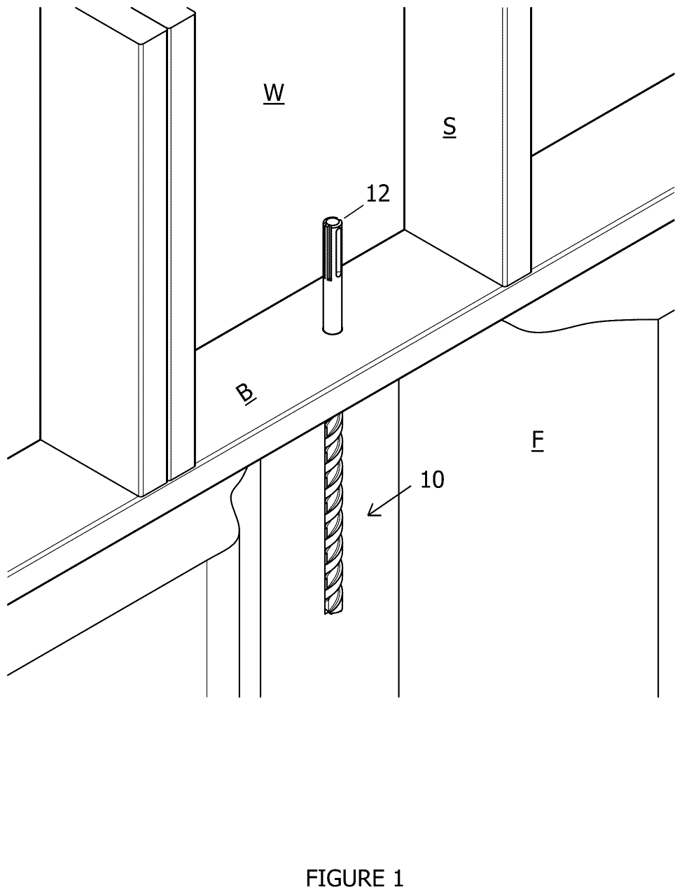

FIG. 1 depicts a situation in which embodiments of the present invention may be utilized to recover a tool bit 10 which become stuck during a drilling operation with a rotary hammer. As illustrated in FIG. 1, tool bit 10 having a shank with spline 12 was being used for creating an anchor hole in a cured concrete foundation F adjacent a rebar-reinforced retaining wall W. Vertical framing members S and footing members B have already been disposed upon the foundation F, so it is to be appreciated that if tool bit 10 becomes stuck during the rotary hammer operation, getting the tool bit 10 free presents a substantial challenge because of the limited working room and the lack of an effective reverse mode in most rotary hammers.

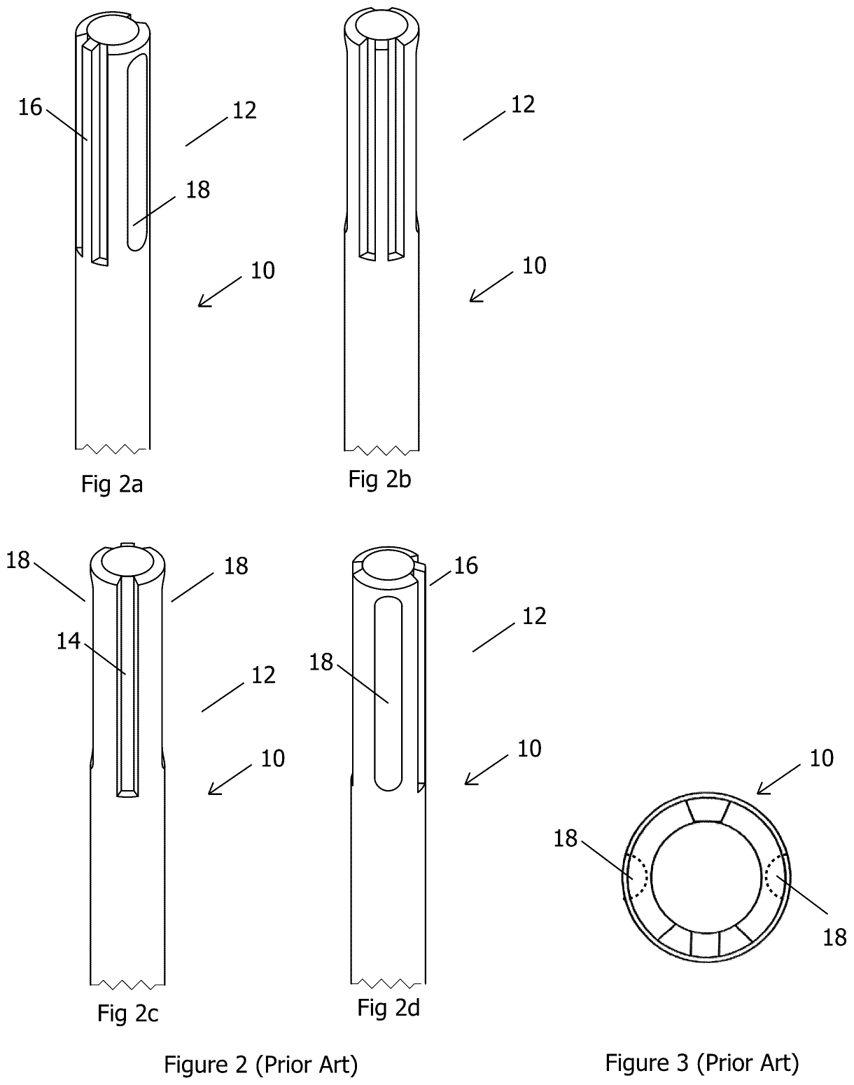

FIGS. 2a-2d of FIG. 2 show different views about the shank 12 of an SDS-Max tool bit 10 utilized with a rotary hammer. The shank 12 of the SDS-Max tool bit 10 has an axial keyway 14 on one side, an extending axial key 16 on the side opposite the axial keyway, and elliptically-shaped notches 18 on opposing sides of the shank 12.

FIG. 3 shows a top view of the tool bit depicted in FIG. 2, thereby showing the splined shank 12 of the tool bit. Embodiments of the present adapter are configured to securely attach to spined end 12 of an SDS-Max and other known rotary hammer bits and thereby provide an operable couple between an impact wrench 1000 and the stuck tool bit 10, thereby allowing the tool bit to be rotated in a reverse and forward direction as required to dislodge the tool bit 10 from a matrix such as concrete foundation F depicted in FIG. 1. Impact wrench 1000 may be actuated pneumatically, hydraulically or electrically. The term “impact wrench” utilized herein shall be understood to include all three power sources.

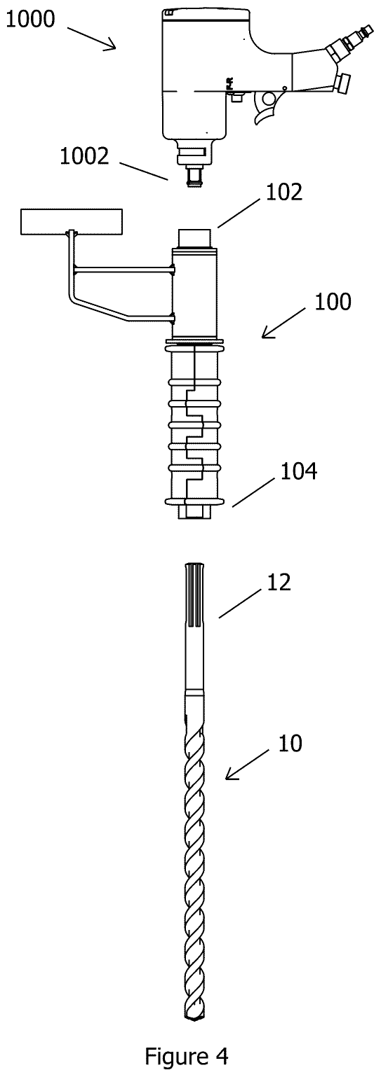

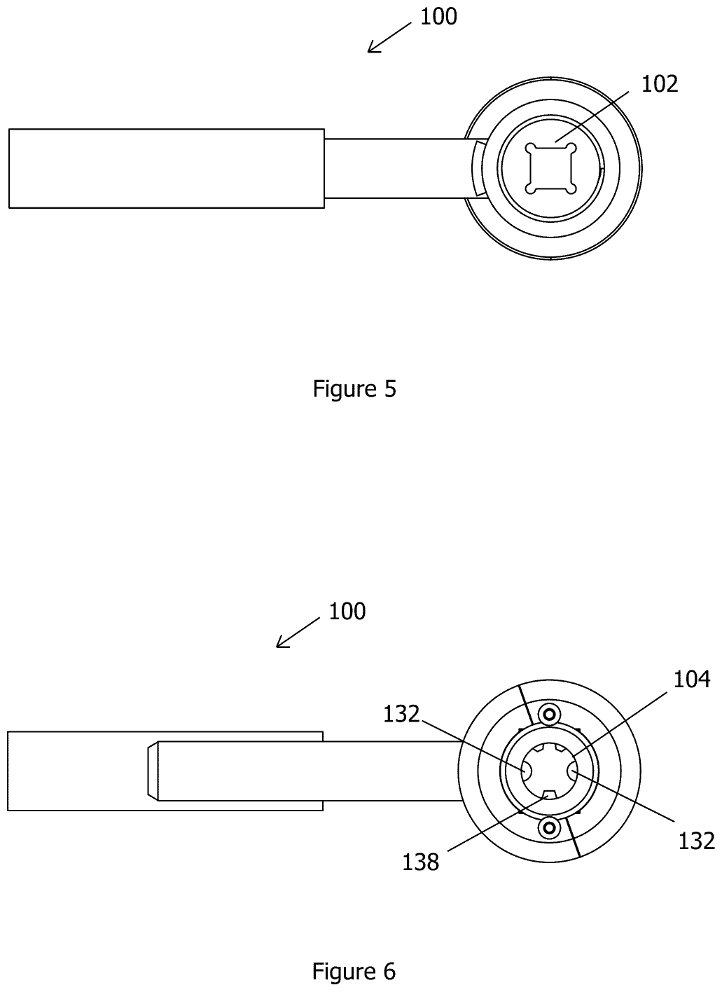

FIG. 4 depicts an embodiment of the presently disclosed adapter 100 positioned between a tool bit 10 and an impact wrench 1000. The impact wrench 1000 is coupled to tool bit 10 by inserting anvil 1002 of the impact wrench into a square drive receptacle 102 of adapter 100 as shown in FIG. 5. As shown in FIG. 6, adapter 100 further has chuck mechanism 104 which is adapted to receive and attach to the splined end 12 of the tool bit 10.

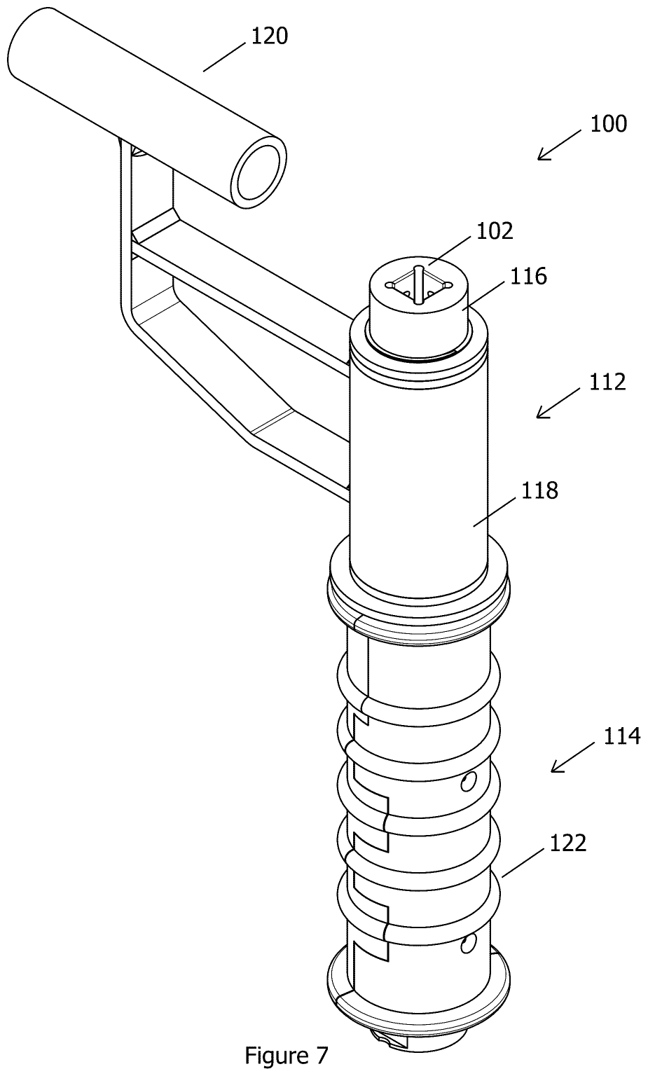

FIG. 7 depicts a perspective view of an embodiment of the presently disclosed adapter 100 showing the upper end 112 and lower end 114. FIG. 7 shows the square drive receptacle 102 which is set within an end of shaft member 116. Once tool bit 10 has been coupled to impact wrench 1000 by adapter 100, reverse and forward rotation may be applied to the tool bit by the impact wrench. This rotation is applied through shaft member 116 which extends through sleeve member 118 of upper end 112 and partially into lower end 114 where shaft member 116 couples with the chuck mechanism 104 as described below to impart rotational motion to the chuck mechanism and tool bit 10 which is locked within the chuck mechanism. Shaft member 116 may rotate freely within upper end 112 while lower end 114 rotates with the rotational motion of the impact wrench anvil 1002, turning the tool bit 10. Upper end 112 may further comprise an extending handle assembly 120 which attaches to sleeve member 118. Lower end 114 may comprise a grip member 122.

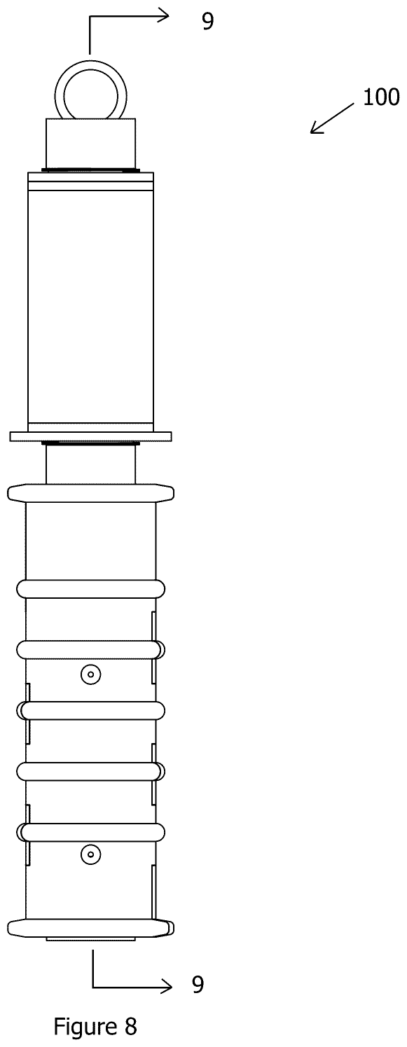

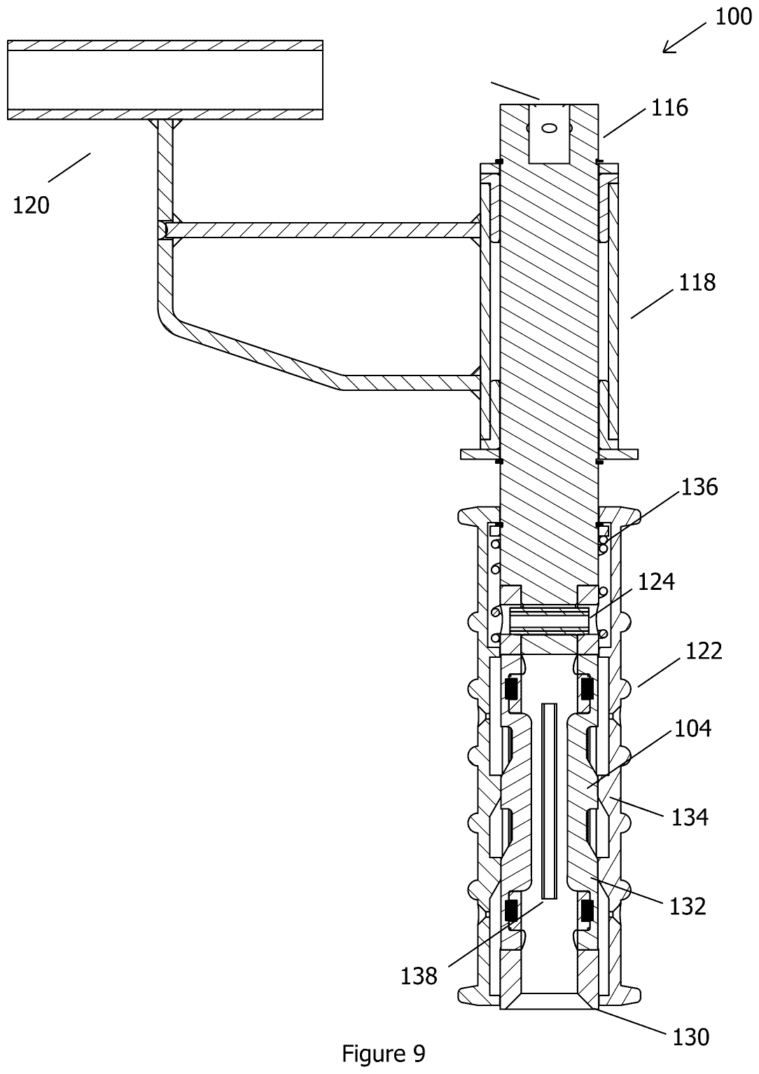

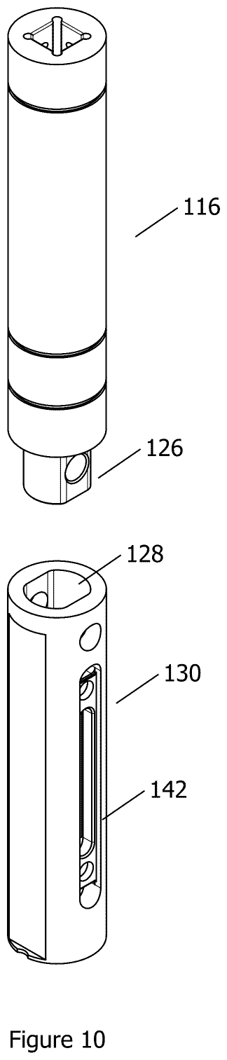

FIG. 9, taken along line 9-9 of FIG. 8, shows a sectioned view of an embodiment of the presently disclosed adapter 100. As shown in FIG. 9, shaft member 116 couples with chuck mechanism 104 by use of a connection pin 124 which is inserted through aligned apertures in the shaft member and the chuck mechanism. The coupling mechanism used between the shaft member 116 and chuck mechanism 104 is configured to provide a joint which allows the application of significant torque without slippage or failure. An example of such an arrangement is depicted in FIG. 10, showing how shaft member 116 may have an extending member 126 which may engage connection aperture 128 of chuck shaft member 130 with a snug fit and secured by the insertion of the connection pin 124 through the aligned apertures.

The adapter 100 depicted in FIG. 9 shows detail of the chuck mechanism 104. FIG. 9 shows the chuck mechanism 104 in a closed position, i.e., the position in which the chuck mechanism would engage and lock onto the splined end 12 of the tool bit 10, which is not shown in FIG. 9. Chuck mechanism 104 is considered to be in the closed position because of the interaction between key members 132 with the internal wedges 134 which are axially disposed within the interior of the grip member 122. In the closed position, as depicted in FIG. 9, the most inwardly extending portions of wedges 134 are in facing contact with the most outwardly extending portions of key members 132. As shown in FIG. 10, chuck shaft member 130 comprises opposite facing elliptical openings 142 through which key members 132 extend to engage the elliptically-shaped notches 18 on opposing sides of the shank 12.

The chuck mechanism 104 is biased into the closed position by spring 136. FIG. 9 also shows an inwardly facing rail member 138. Rail member 138 engages the axial keyway 14, shown in FIG. 2, of the shank 12 of the tool bit 10.

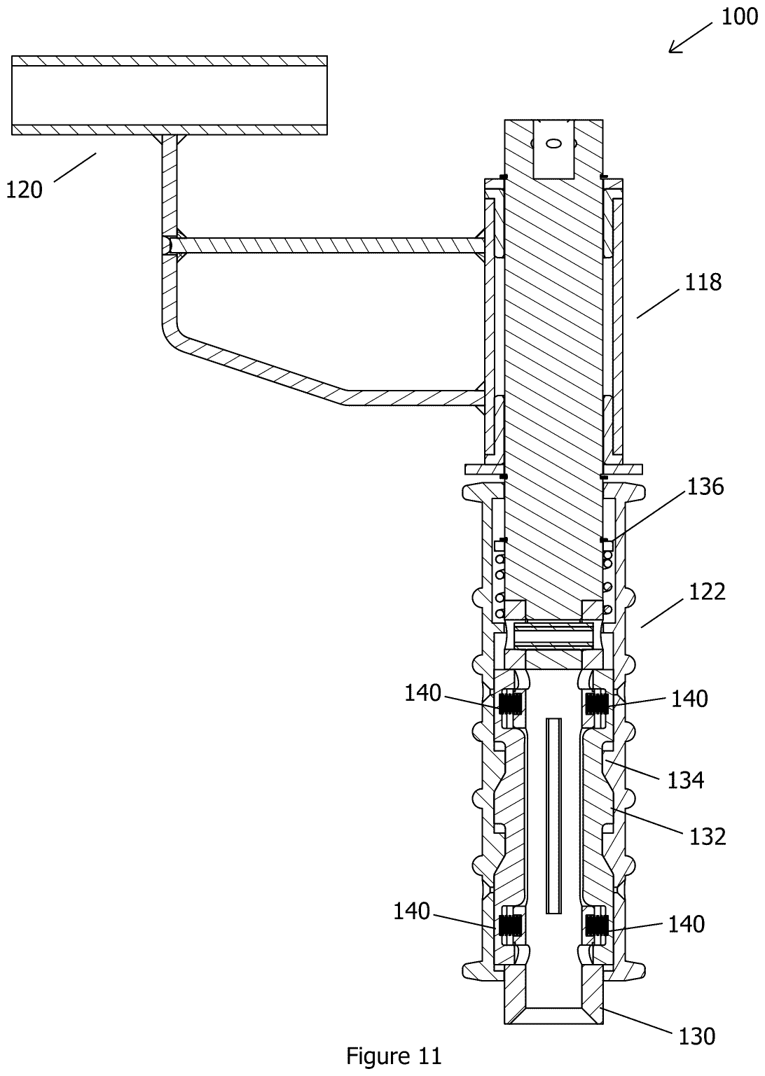

FIG. 11 depicts adapter 100 with the chuck mechanism 104 in an open position, i.e., the position in which the chuck mechanism is ready to slide over the shank 12 of the tool bit 10. In the open position, as depicted in FIG. 11, the most inwardly extending portions of wedges 134 are in facing contact with inward recesses of key members 132, allowing the key members to be radially shifted outward, thereby increasing the diameter of the throat of the chuck mechanism 104. In order to place the chuck mechanism in the open position, the operator will slide grip member 122 along shaft member 116 against the resistance of spring 136. Springs 140 assist the key members 132 in moving radially outward, to facilitate the removal of tool bit 10 from the chuck mechanism.

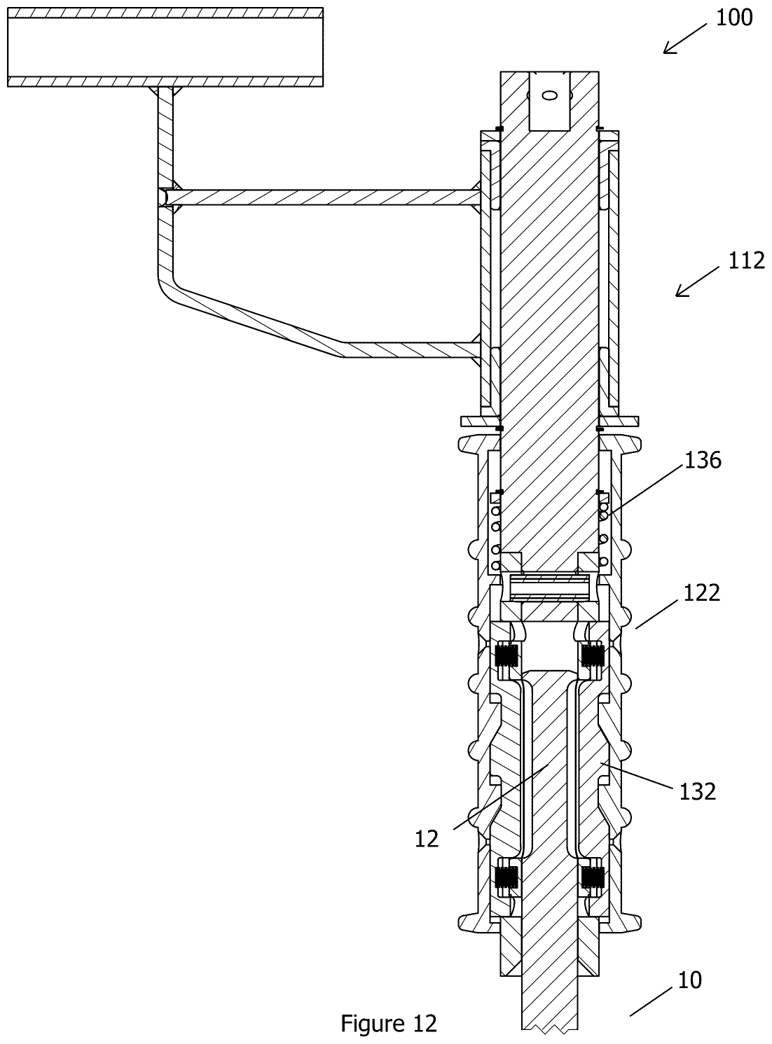

FIG. 12 depicts adapter 100 with the chuck mechanism 104 in the open position with shank 12 of a tool bit 10 set within the chuck mechanism. As described above, chuck mechanism 104 has been placed in the open position by reciprocating grip member 122 toward upper end 112 thereby compressing spring 136. As shown in FIG. 12, key members 132 are extending radially outward away from the shank 12 of the tool bit 10.

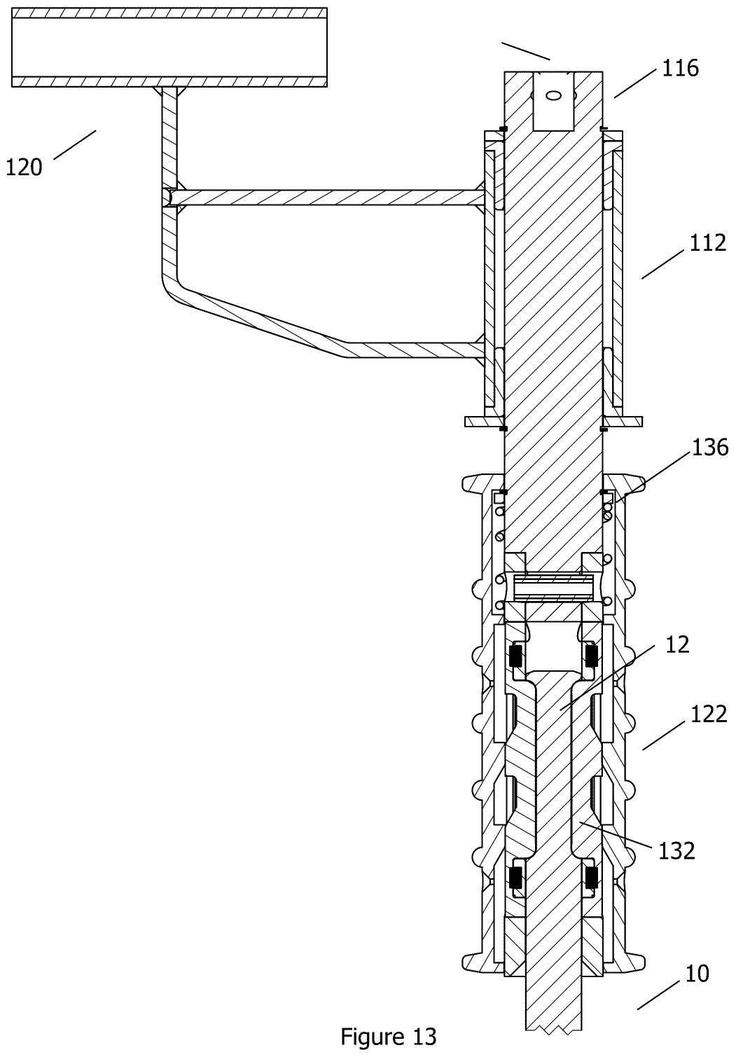

FIG. 13 depicts adapter 100 with the chuck mechanism 104 in the closed position locked around the shank 12 of tool bit 10. FIG. 13 shows how key members 132 have been extended into the elliptically-shaped notches 18 on opposing sides of the shank 12 of the tool bit 10.

The chuck mechanism is maintained in the closed position by spring 136. In this position, the anvil 1002 of an impact wrench 1000 may be set within square drive receptacle 102 and the impact wrench may apply rotational motion to shaft member 116 which translates the motion to the chuck mechanism 104 and to the tool bit 10. Manual upward force may be applied to extending handle assembly 120 to assist in the dislodging of the stuck tool bit 10.

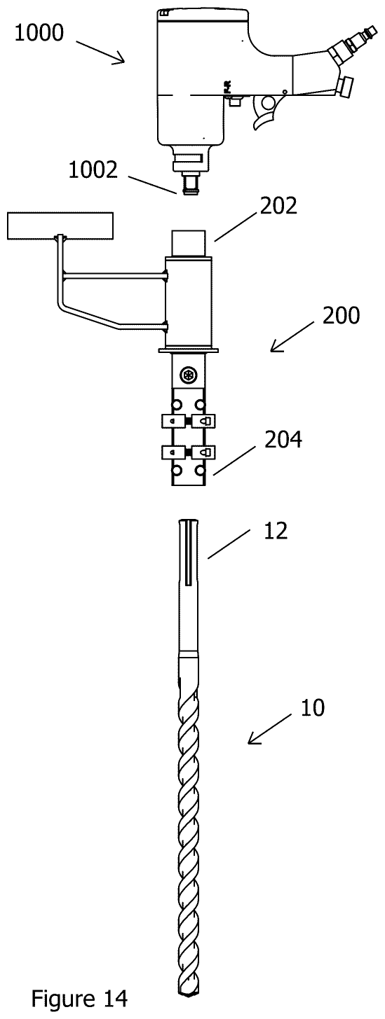

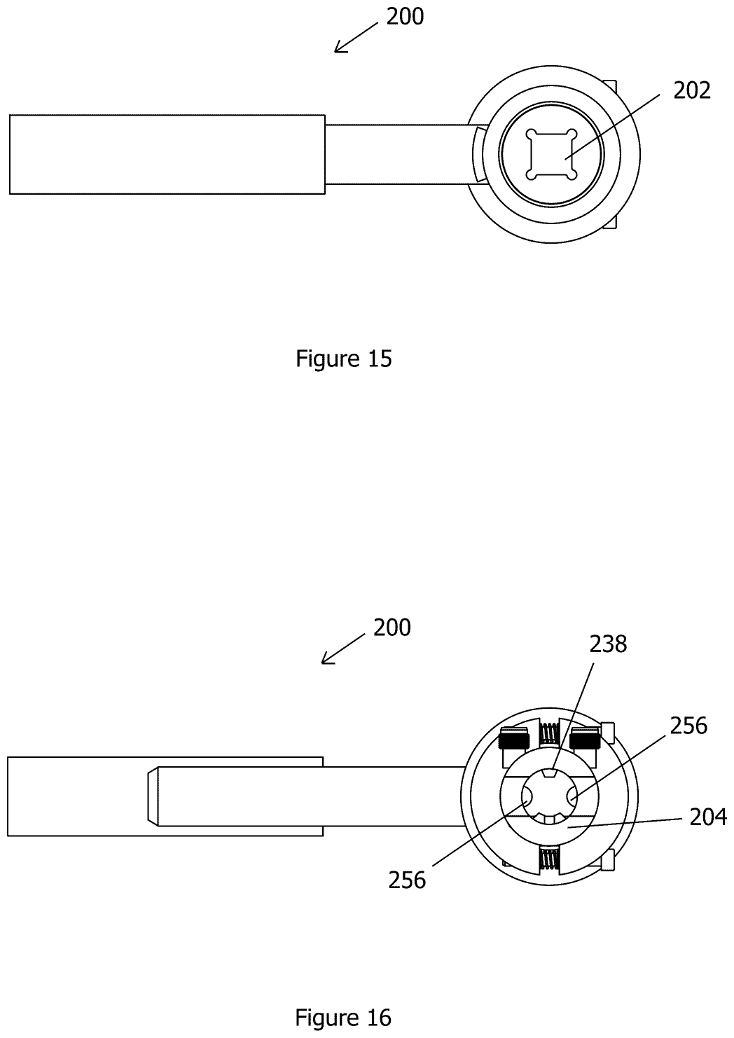

An alternative embodiment of the invention is identified as adapter 200. FIG. 14 depicts adapter 200 positioned between a tool bit 10 and an impact wrench 1000 in the same manner as the above-described embodiment. Similar to the above-described embodiment, impact wrench 1000 is coupled to tool bit 10 by inserting anvil 1002 of the impact wrench into a square drive receptacle 202 of adapter 200 as shown in FIG. 15. As shown in FIG. 16, adapter 200 further has chuck mechanism 204 which is adapted to receive and attach to the shank 12 of the tool bit 10.

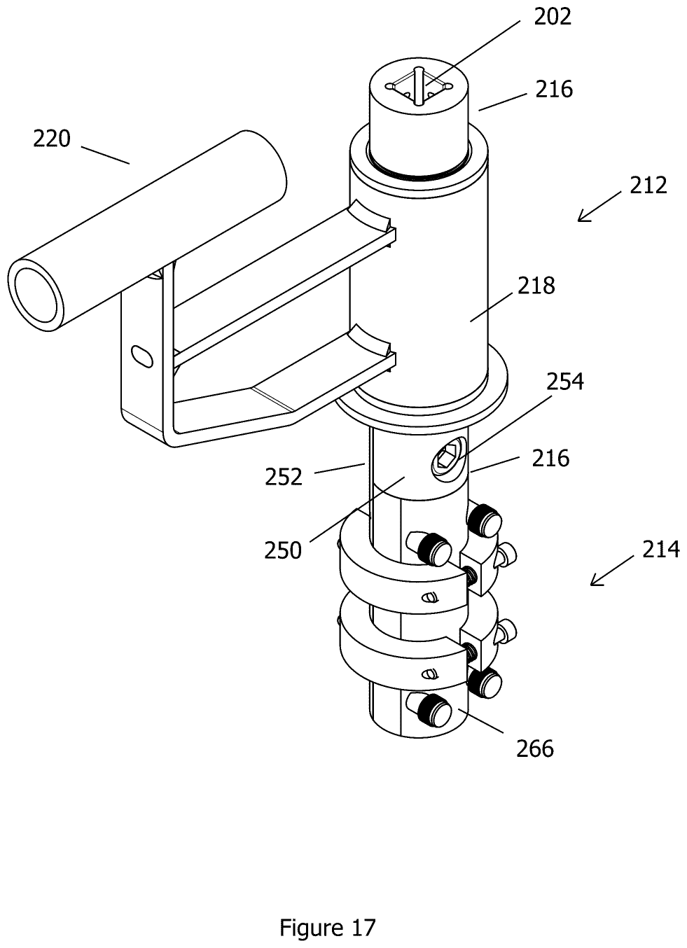

FIG. 17 depicts a perspective view of an embodiment of the presently disclosed adapter 200 showing the upper end 212 and lower end 214. FIG. 17 shows the square drive receptacle 202 which is set within an end of shaft member 216. Once tool bit 10 has been coupled to impact wrench 1000 by adapter 200, reverse and forward rotation may be applied to the tool bit by the impact wrench. This rotation is applied through shaft member 216 which extends through sleeve member 218 of upper end 212 and partially to lower end 214 where the lower end 250 of shaft member 216 couples to chuck plate 252 with bolt 254 to impart rotational motion to the chuck mechanism 204 and tool bit 10 which is locked within the chuck mechanism. Shaft member 216 may rotate freely within upper end 212 while lower end 214 rotates with the rotational motion of the impact wrench anvil 1002, turning the tool bit 10. Upper end 212 may further comprise an extending handle assembly 220 which attaches to sleeve member 218.

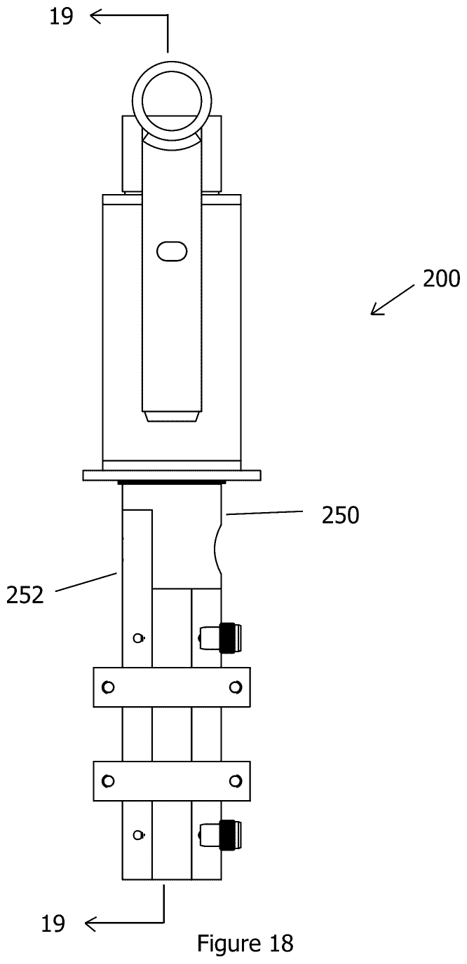

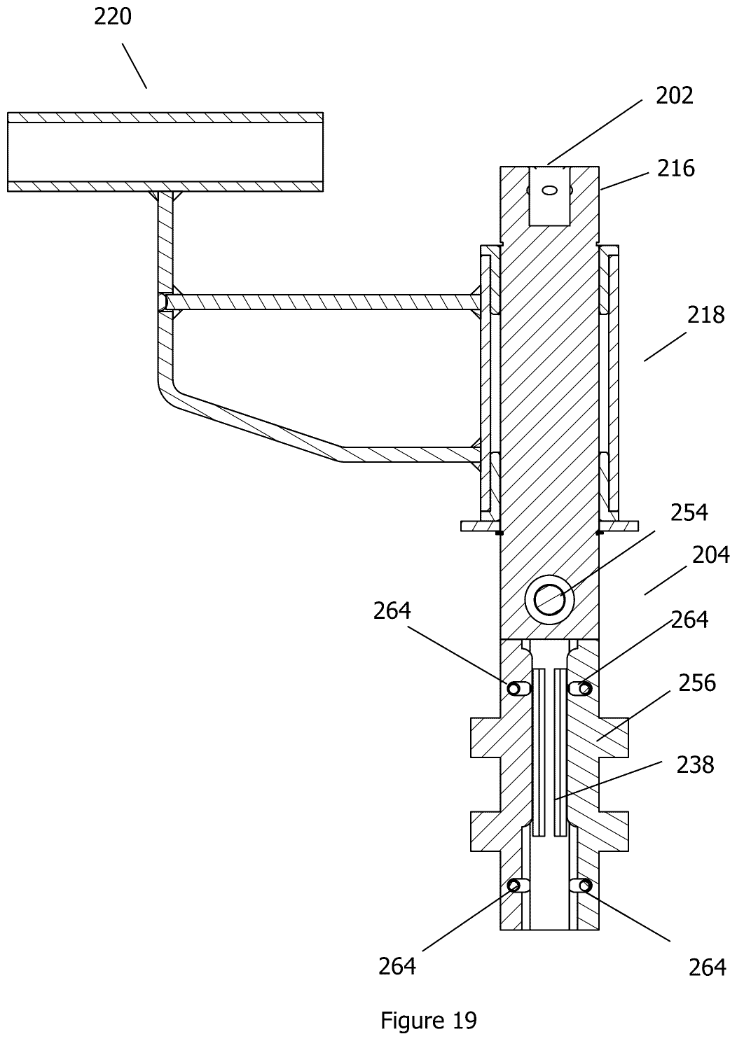

FIG. 19, taken along line 19-19 of FIG. 18, shows a sectioned view of the second embodiment of adapter 200. As shown in FIGS. 18 and 19, shaft member 216 has a lower end 250 which couples in substantial facing relationship with chuck plate 252 of chuck mechanism 204 and connected together by a high strength bolt 254 such that a strong connection is formed between shaft member 216 and chuck mechanism 204 which is configured to allow the application of significant torque without failure in the connection. High strength bolt 254 has a head which may be disposed within a counter-sunk aperture in lower end 250 and has a substantial length which makes up into threads set within chuck plate 252. FIG. 19 also shows inwardly facing rail members 238. Rail members 238 are configured to receive the extending axial key 16, shown in FIG. 2, of the shank 12 of the tool bit 10.

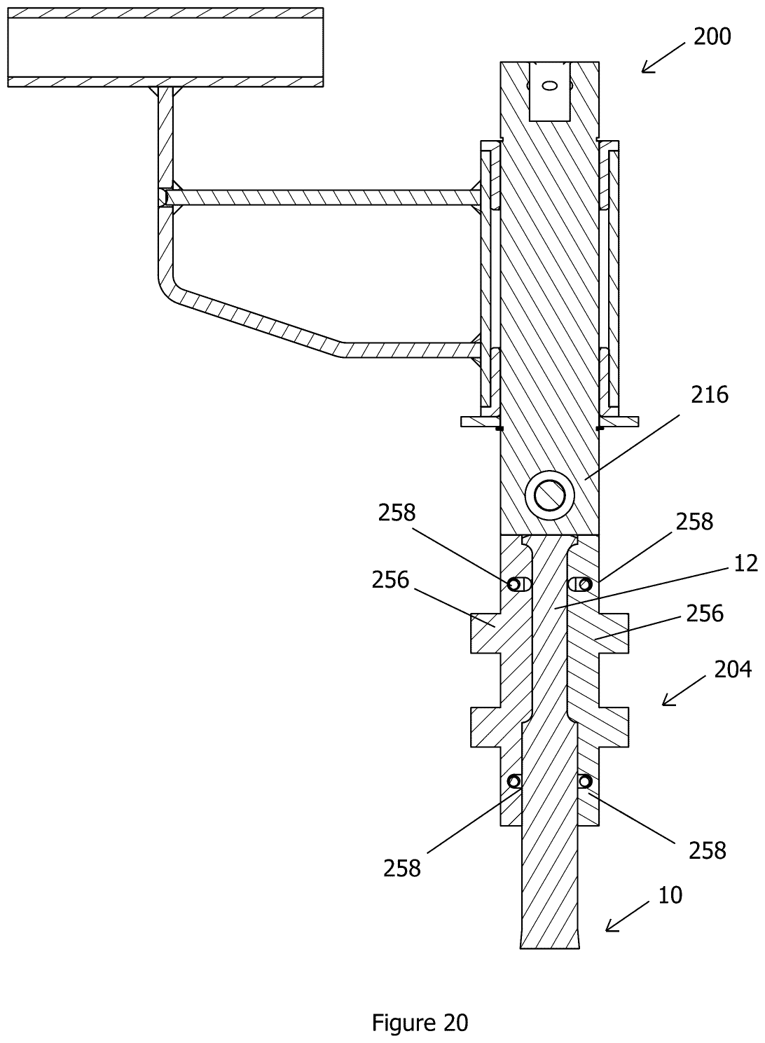

FIG. 20 depicts a shank 12 of a rotary hammer bit 10 positioned within a closed chuck mechanism 204. Chuck mechanism 204 comprises sliding key members 256 which translate radially inward and outward on guide pins 258 which extend through slots 264 in each of the slide key members. In the closed position, sliding key members 256 are translated radially inward to each engage the elliptically-shaped notches 18 on opposing sides of the shank 12 of the tool bit 10. Guide pins 256 extend through cover plate 266.

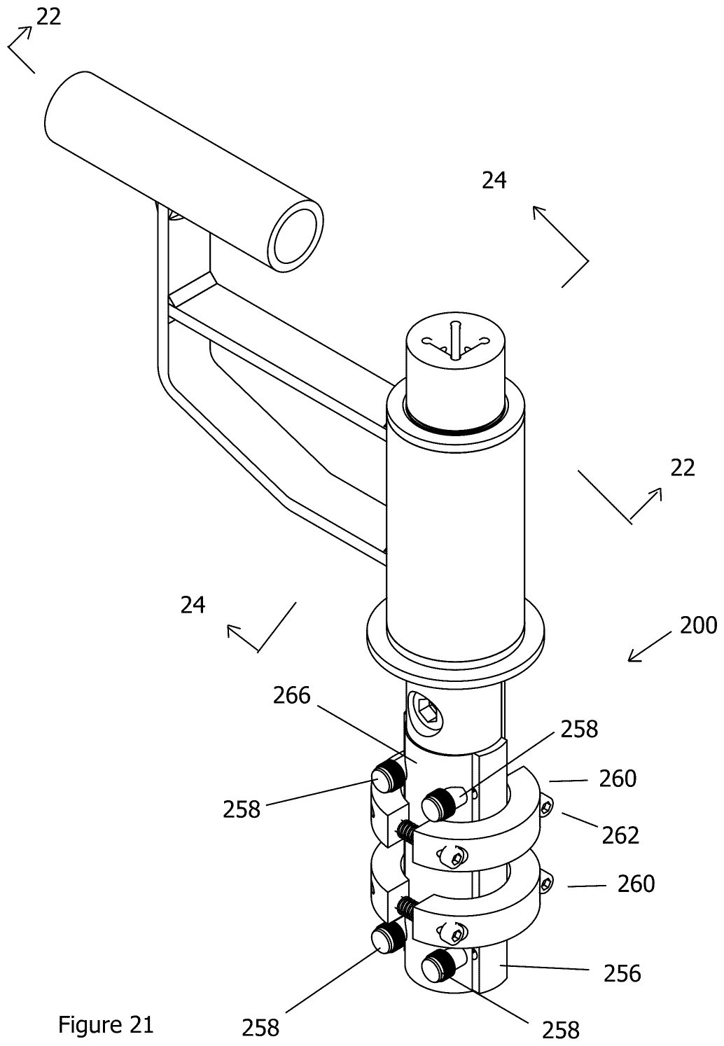

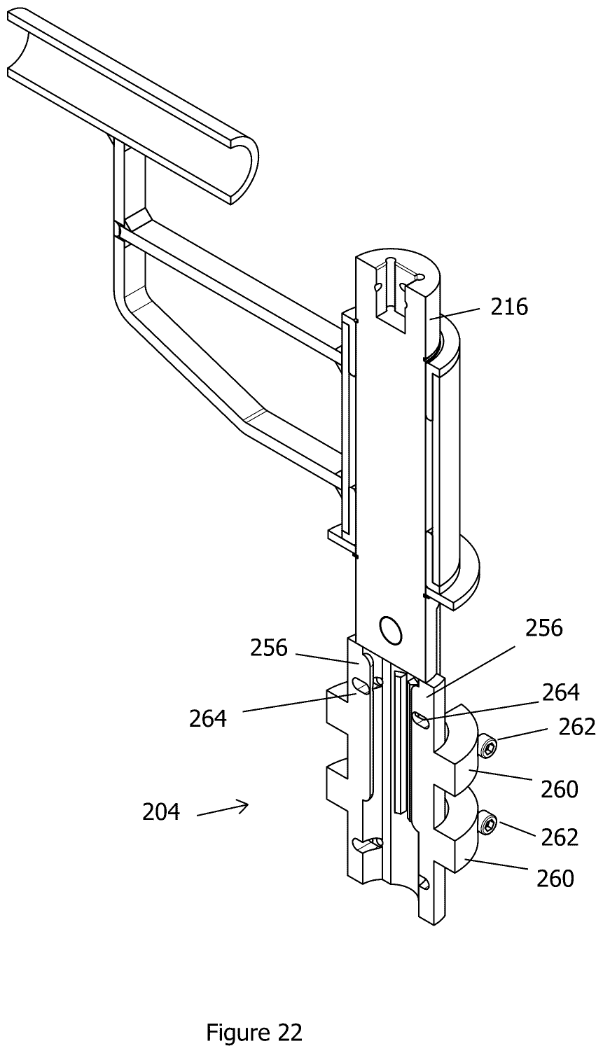

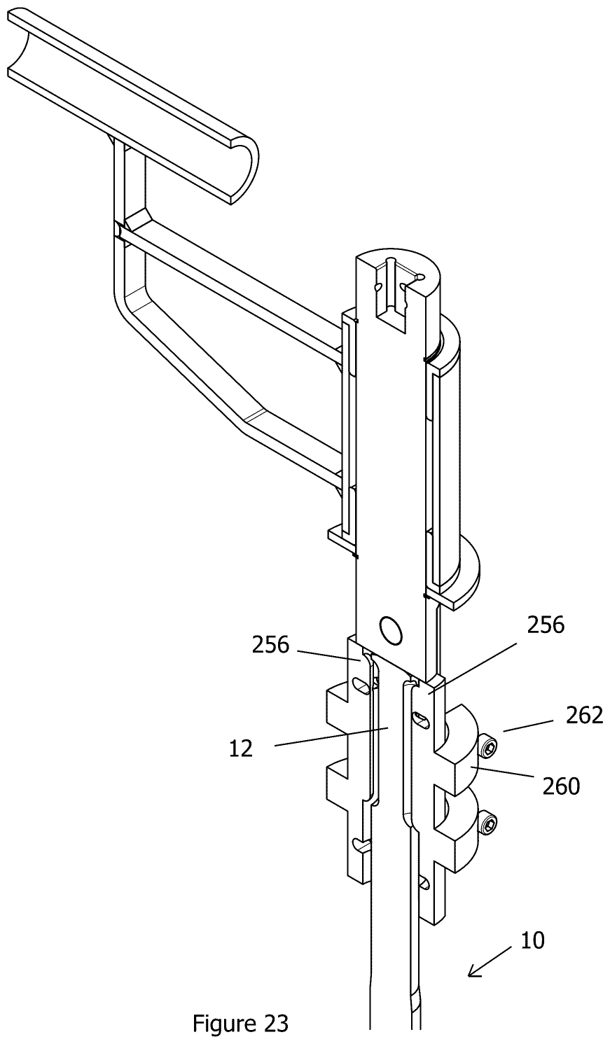

FIG. 21 and the sectional view of FIG. 22 depict the sliding key members 256 translated radially outward on guide pins 258 thereby placing chuck mechanism 204 in an open position and ready to receive the shank 12 of the tool bit 10 as depicted in FIG. 23. FIGS. 21 through 23 further show the compression rings 260 which, in conjunction with fasteners 262, are utilized to apply a radially inward force to the sliding key members 256 and thereby close the chuck mechanism 204 about the shank 12.

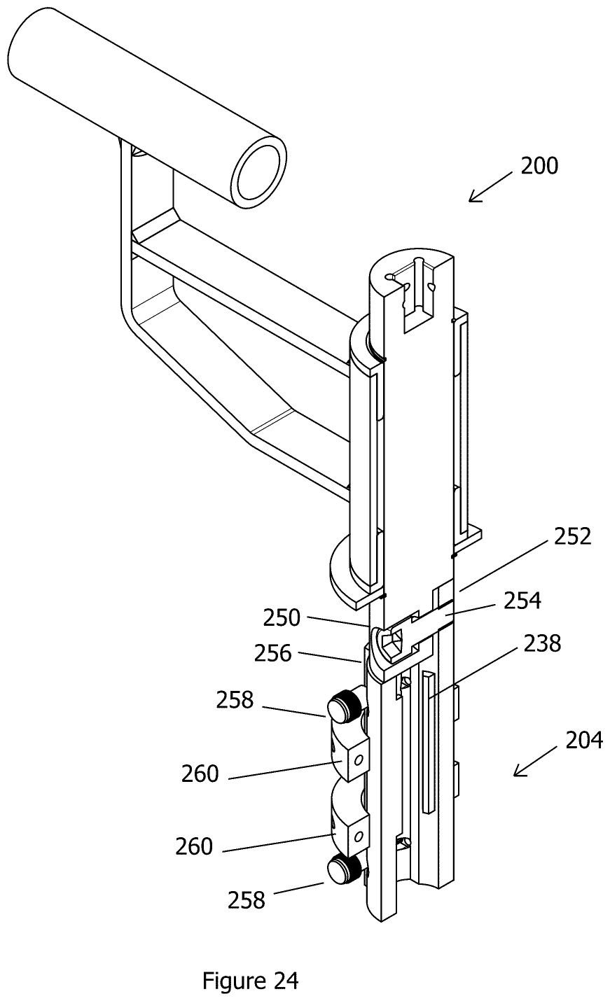

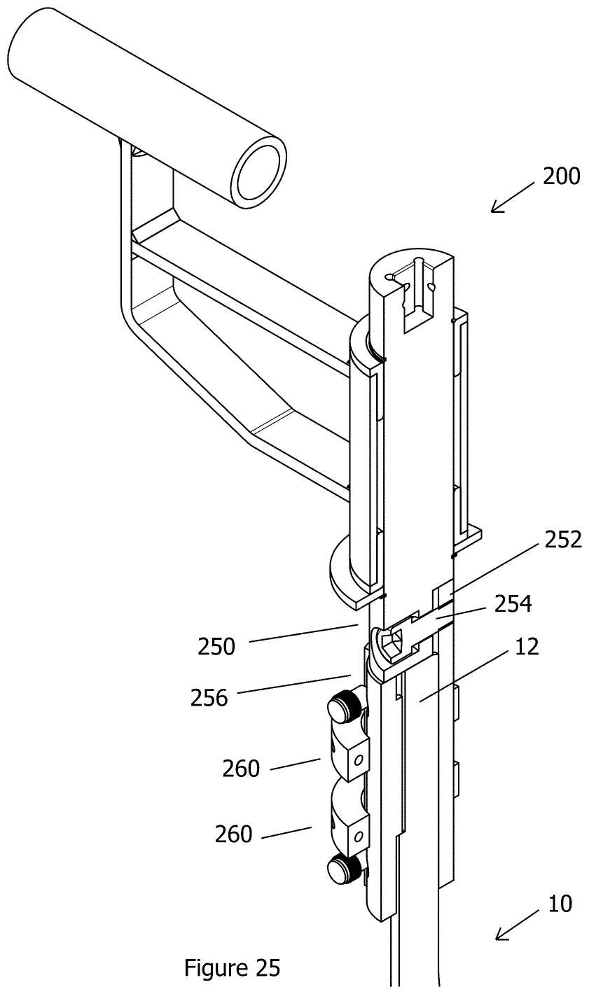

The sectioned views of FIGS. 24 and 25 show a different view of the chuck mechanism 204 showing further detail of the joint between lower end 250 of shaft member 216 and chuck plate 252, showing the substantial engagement of high strength bolt 254 into chuck plate 252. FIG. 24 depicts the chuck mechanism 204 in a position ready to receive the shank 12 of the tool bit 10 while FIG. 25 depicts the shank 12 of a tool bit disposed within the chuck mechanism. It is to be appreciated that the chuck mechanism 204 is configured so that substantial engagement force may be applied by the chuck mechanism to the shank 12.

Having thus described the preferred embodiment of the invention, what is claimed as new and desired to be protected by Letters Patent includes the following:

What is claimed is:

1. An adapter for use in combination with an impact wrench, the adapter configured to couple the impact wrench to a splined shank of a tool bit for a rotary hammer, the adapter comprising:
a shaft member comprising a proximate end and a distal end, the proximate end comprising a rear facing axial opening configured to receive an anvil from the impact wrench;
a sleeve member which encloses a first portion of the shaft member allowing the shaft member to rotate within the sleeve member; and
a chuck assembly coupled to the distal end of the shaft member, the chuck assembly configured to rotate as the shaft member rotates, the chuck assembly further comprising a forward end comprising an axial opening configured to receive the splined shank of the tool bit, the chuck assembly further comprising a key member configured to releasably engage the splined shank of the tool bit such that when the key member is engaged with the spline shank, the tool bit rotates as the chuck assembly rotates.

2. The adapter of claim 1 further comprising an extending handle member attached to the sleeve member.

3. The adapter of claim 1 wherein the chuck assembly comprises a chuck shaft member attached to the distal end of the shaft member.

4. The adapter of claim 3 wherein the chuck assembly comprises a grip member which encloses the chuck shaft member.

5. The adapter of claim 4 wherein the chuck assembly comprises a pair of opposite facing key members which are configured to engage the splined shank of the tool bit upon an interaction of each key member with a corresponding inwardly extending wedge disposed within the grip member.

6. The adapter of claim 5 wherein the pair of opposite facing key members are configured to release the splined shank of the tool bit upon an application of a reciprocal motion to the grip member which shifts the grip member from a locked position, in which the key members are engaged with the splined shank, to a released position, in which the key members are disengaged from the splined shank.

7. The adapter of claim 6 further comprising a spring which biases the grip member in the locked position.

8. The adapter of claim 7 further comprising a plurality of springs which urge the key members away from the splined shank of the tool bit when the grip member is in the released position.

9. The adapter of claim 1 wherein the chuck assembly comprises a pair of opposite facing key members configured to translate radially inward to engage the splined shank, the key members configured to be releasably retained in a locked engagement with the splined shank.

10. The adapter of claim 9 wherein the key members are retained in the locked engagement by a compression ring which encircles the pair of opposite facing key members.

11. The adapter of claim 9 wherein each of the opposite facing key members comprises a radially oriented slot and each of the opposite facing key members attach to the chuck assembly by a guide pin inserted through the radially oriented slot of each of the opposite facing key members.

12. The adapter of claim 11 wherein the shaft member comprises a lower end and the chuck assembly comprises a chuck plate which attaches to the lower end of the shaft member in a substantial facing relation, wherein the opposite facing key members are attached to the chuck plate by the guide pins.

13. The adapter of claim 12 wherein the chuck plate is attached to the lower end of the shaft member by a bolt.

14. A method of removing a rotary hammer tool bit from a foundation, the method comprising the following steps:
disengaging the rotary hammer from the rotary hammer tool bit;
attaching an adapter to a spline of the rotary hammer tool bit, wherein the adapter comprises a shaft member comprising a proximate end and a distal end, the proximate end comprising a rear facing axial opening configured to receive an anvil from an impact wrench, the adapter further comprising a sleeve member through which the shaft member extends and freely rotates, the adapter further comprising a chuck assembly configured to releasably attach to the spline of the rotary hammer bit;
inserting the anvil of the impact wrench into the rear facing axial opening of the shaft member of the adapter; and
engaging the impact wrench to apply a counter-clockwise rotation to the rotary hammer bit.

15. The method of claim 14 wherein an extending handle member is attached to the sleeve member and an upward force is applied to the handle member.
